(19) United States
(12) Patent Application Publication
(10) Pub. No.: US 2008/0251969 A1
(43) Pub. Date: Oct. 16, 2008

(54) Bladder Molding Systems and Methods For Fabricating Composite Articles

(76) Inventors: William R. Isham, Alpine, UT (US); Stephen N. Webber, Alpine, UT (US); Boyd Wilkinson, Brighton, CO (US)

Correspondence Address: THORPE NORTH & WESTERN, LLP., P.O. Box 1219, SANDY, UT, 84091-1219, US

(21) Appl. No.: 12/033,882

(22) Filed: Feb. 19, 2008

Related U.S. Application Data
(60) Provisional application No. 60/901,847, filed on Feb. 16, 2007.

(51) Int. Cl. B29C 33/40

(52) U.S. Cl. 264/316; 425/89

(57) ABSTRACT

A method for forming composite articles from a thermoplastic preform using a bladder molding system. In one aspect, the method comprises suspending the preform above a tensioned release layer in an indexed manner prior to heating and forming the preform. In another aspect, the method comprises cold loading the preform into the bladder molding system about the mold cavity and subsequently heating and forming the preform without further handling the preform.

### RELATED APPLICATIONS

The present application claims the benefit of U.S. Provisional Application Ser. No. 60/901,847, filed Feb. 16, 2007, and entitled, “Bladder Molding Systems and Methods for Fabricating Composite Articles,” which is incorporated by reference in its entirety herein.

### FIELD OF THE INVENTION

The present invention relates generally to the fabrication or manufacture of composite articles, such as channel and other similarly shaped composite articles, and more particularly to bladder molding systems and methods for the manufacture of composite articles from pre-assembled, multi-ply thermoplastic reinforced fiberglass laminates.

### BACKGROUND OF THE INVENTION AND RELATED ART

Bladder molding systems and processes for use in the fabrication of composite articles are well known. Traditional bladder molding processes utilize a female mold, into which a thermoset preform and flexible bladder (e.g., one made of latex, silicon, or nylon) are placed. The bladder is located inside the preform during the lay-up process. Once the contents are placed inside the mold, it is closed and held shut. The mold is heated, the thermoset matrix is cured and cooled, the mold opened, and the part removed. Depending on the part design, the bladder may remain inside the part or be removed for additional use. Bladder molding offers exceptional consolidation, since pressures against complex shapes can be in excess of 100 psi. Part quality, in terms of minimal voids, good surface finish, consistency, and strength-to-weight ratio, is exceptionally high with bladder molding. Common products built using this technology are bicycle frames, golf shafts, and various composite tubing.

Although traditional bladder molding systems and methods have proven to be beneficial in several respects, there are some significant limitations. One of the more significant limitations is that, while well suited for preforms formed from thermoset materials, traditional bladder molding systems and methods are not well suited for preforms formed from thermoplastic materials. Indeed, the use of traditional bladder molding systems and methods to form composite articles from thermoplastic preforms poses many different process challenges. For example, traditional methods tend to fill all or a substantial portion of the void in the mold cavity around the preform with the bladder inflated by air or liquid. This requires a significant volume of air or liquid to fill the bladder and possibly heating or cooling as part of the molding process, resulting in increased cycle times and expense. Traditional methods also typically require a substantially stronger mold and clamping system. They also typically require the preform be completely in the mold prior to inflating the bladder, which further requires a method of indexing and inserting the preform into the mold prior to interfacing with the bladder molding system.

### SUMMARY OF THE INVENTION

In light of the problems and deficiencies inherent in the prior art, the present invention seeks to overcome these by providing a method for fabricating thermoplastic-based composite articles or parts using a bladder molding system suited for such a purpose. In some embodiments, the present invention provides a unique method of indexing the preform by suspending it above the mold cavity. In one aspect, the present invention contemplates suspending and supporting the preform on a tensioned release film above the mold cavity. In another aspect, the present invention contemplates suspending and supporting the preform on the lip of the mold itself centered over the female cavity. Without moving the preform, the part is heated, the heaters retracted, and the mandrel with a covered bladder moved down into contact with the preform. The mandrel uniformly pushes (without requiring additional indexing) the heated part into the mold cavity. The mandrel with the bladder covering is then clamped into place inside the mold and the bladder expanded, pushing against the interior walls of the mold as well as against the mandrel.

In accordance with invention as embodied and broadly described herein, the present invention features a method for facilitating fabrication of a composite article formed from a thermoplastic preform, and within a bladder molding process, the method comprising providing a mandrel/bladder assembly operable to conform the preform to one or more walls of a mold cavity of a mold, the mandrel/bladder assembly comprising a mandrel sized and configured to fit within the mold cavity, and to define, at least in part, a volume of space between the mandrel and the preform, each as positioned within the mold cavity, and an actuatable bladder supported about at least a portion of and operable with the mandrel, and configured to fill the volume of space upon being actuated to cause the preform to conform to the mold cavity; and facilitating operation of the mandrel/bladder assembly with a bladder molding system to fabricate a composite article.

The present invention also features an exemplary method for manufacturing a composite article formed from a thermoplastic preform, and within a bladder molding process, the method comprising obtaining a thermoplastic composite preform; obtaining a mold having a mold cavity configured to facilitate formation of a desired composite article; supporting the mold to be operable with a bladder molding system; cold loading a composite preform onto a surface of the mold and about the mold cavity, the mold being configured to support the preform over the mold cavity; heating the preform to a pre-determined temperature in cooperation with a pre-determined molding temperature; positioning a mandrel/bladder assembly of the bladder molding system proximate the preform and the mold cavity, said mandrel/bladder assembly comprising a mandrel operable with a bladder; causing the mandrel/bladder assembly to contact the preform to initiate formation of any release film and the preform in the mold cavity, and to index the preform within the mold cavity, said mandrel reducing a volume of space within said mold cavity between said mandrel and said preform; causing the mandrel/bladder assembly to conform the preform to the mold cavity; cooling the preform to produce a composite article being at least partially finished; releasing the mandrel/bladder assembly from the mold cavity and the composite article; and removing the formed composite article from any release film and the mold cavity.

The present invention features another exemplary method for manufacturing a composite article formed from a thermoplastic preform, and within a bladder molding process, the method comprising obtaining a thermoplastic composite preform; obtaining a mold having a mold cavity configured to facilitate formation of a desired composite article; supporting the mold to be operable with a bladder molding system; indexing the preform on a release film suspended above the mold cavity, the release film being configured to support the preform in a suspended manner; heating the preform to a pre-determined temperature in cooperation with a pre-determined molding temperature; positioning a mandrel/bladder assembly of the bladder molding system proximate the suspended or partially suspended preform and the mold cavity, said mandrel/bladder assembly comprising a mandrel operable with a bladder; causing the mandrel/bladder assembly to contact the preform to initiate formation of the release film and the preform in the mold cavity, and to index the preform within the mold cavity, said mandrel reducing a volume of space within said mold cavity between said mandrel and said preform; causing the mandrel/bladder assembly to conform the preform to the mold cavity; cooling the preform to produce a composite article being at least partially finished; releasing the mandrel/bladder assembly from the mold cavity and the composite article; and removing the formed composite article from the release film and the mold cavity.

The present invention further features various bladder molding systems for use in forming composite articles in accordance with the methods described herein. In one exemplary embodiment, the present invention features a bladder molding system for fabricating a composite article from a thermoplastic preform, the system comprising a framework configured to operably support one or more components thereon; a flat platen operable with the framework and configured to provide a working surface about which a mold having a mold cavity may be supported; means for supporting the preform about the mold cavity; a mandrel/bladder assembly movably supported about the framework, and configured to facilitate insertion, forming and indexing of said preform within said mold cavity, said mandrel/bladder assembly comprising a mandrel having bottom, top and side surfaces, said mandrel being sized and configured to fit within said mold cavity, and to provide a volume of space between at least said mandrel and said preform, each as positioned within said mold cavity, and an actuatable bladder supported about and operable with said mandrel, and configured to fill said volume of space to cause said preform to conform to said mold cavity; and a clamping mechanism configured to secure the mandrel/bladder assembly in a desired position during a pressure cycle. Heaters used to heat the preform prior to being molded may be separate or integral with the bladder molding system.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a flow diagram of a method for forming composite articles from a thermoplastic composite preform in accordance with one exemplary embodiment of the present invention;

FIG. 2 illustrates a flow diagram of a method for forming composite articles from a thermoplastic composite preform in accordance with another exemplary embodiment of the present invention;

FIG. 3 illustrates a general block diagram of a bladder molding system used to form a composite part in accordance with one exemplary embodiment of the present invention; and

FIG. 4 illustrates a general block diagram of a bladder molding system used to form a composite part in accordance with another exemplary embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a method and system for manufacturing channel, u-shaped and other similarly shaped composite articles from a pre-assembled, multi-ply thermoplastic reinforced fiberglass laminate. While the methods and systems discussed herein focus on bladder molding techniques using thermoplastic preforms, one skilled in the art may realize certain advantages and applications for undertaking bladder molding techniques using or incorporating thermoset preforms that are operable with the bladder molding systems and methods of the present invention.

The present invention bladder molding system and method provides several significant advantages with respect to the manufacture of thermoplastic composite articles as compared to prior related bladder molding systems and methods used to fabricate thermoset and/or thermoplastic composite articles, as well as various overall advantages over such prior related bladder molding systems and methods, some of which are recited here and throughout the following more detailed description. Some exemplary advantages include, but are not limited to, the ability to mold and remold a composite article; the ability to add additional material to the composite article in a subsequent molding process, or after a previous molding or remolding process; the ability to provide low-cost, simple machinery that can be custom-fabricated in a short period of time; flexibility to experiment with different laminate schedules and materials without additional costs; the ability to produce a finished part with good consistency and quality; the ability to utilize a prototype machine to begin production of finished parts; in some embodiments, the ability to form or thermoform a composite article with little or no initial handling of the preform, or in other words, the ability to form a composite article from a cold loaded preform; minimal post-forming processing; scaleability to allow for increases in production capacity; the ability to achieve fast cycle rates (fast composite part or article cycling) using bladder molding; the use of relatively inexpensive molds and machinery; use of a mandrel to at least partially fill the mold cavity and to provide a counter force acting on the bladder (counter to the forces on the bladder from the walls of the mold cavity), thus resulting in the ability to reduce or minimize the pressure needed to form or mold the composite article; and easy operation and minimal maintenance.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

### Methods for Forming Composite Structures

The present invention features various methods for forming composite articles using a novel bladder molding system, such as the one described below. Details of exemplary methods are provided here, as well as in the discussion of the various exemplary bladder molding systems.

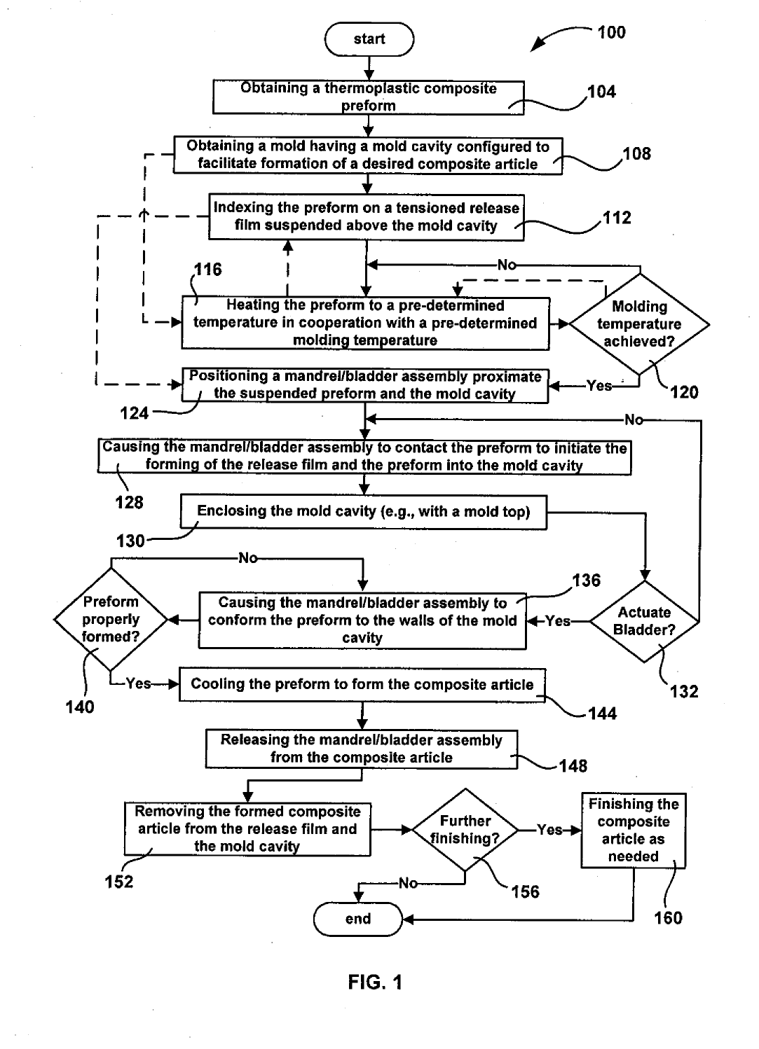

With reference to FIG. 1, illustrated is a flow diagram depicting a bladder molding process, and a method for manufacturing a composite article formed from a thermoplastic preform in accordance with one exemplary embodiment of the present invention. As shown, the method 100 comprises several steps. As illustrated in step 104, the method may comprise obtaining a composite preform, preferably a thermoplastic composite preform. Step 108 comprises obtaining a mold having a mold cavity configured to facilitate formation of a desired composite article. Step 112 comprises indexing the preform on a tensioned release film suspended on or above the mold cavity, the release film being configured to support the preform in a suspended manner, if needed. Step 116 comprises heating the preform to a pre-determined temperature in cooperation with a pre-determined molding temperature. Once heating of the preform has begun, the temperature may be monitored to determine, as shown in step 120, whether a proper molding temperature has been achieved. If not, heating is continued. As illustrated by the phantom lines, alternatively, the step 116 of heating the preform to a predetermined temperature in cooperation with a predetermined molding temperature may be conducted prior to the step 112 of indexing the preform on a tensioned release film suspended above the mold cavity. In this alternative method, the preform may be heated prior to indexing and placement within the bladder molding system, namely about the mold and mold cavity.

Once the preform has reached the proper desired molding temperature, a mandrel/bladder assembly may be positioned proximate the suspended preform and the mold cavity as shown in step 124. In most cases, it will be desirable to evenly and thoroughly heat the preform prior to being inserted into the mold and particularly prior to being formed. Step 128 comprises causing the mandrel/bladder assembly to contact and interact with the preform to initiate the forming of the release film and the preform in the mold cavity. Once the preform is properly positioned within the mold cavity, the mold cavity may be enclosed to provide a suitable enclosure for forming the composite article, as shown in step 130. The mold cavity may be enclosed using various means known in the art, such as via a mold top having a lower or bottom surface designed to interface and be operable with the mandrel/bladder assembly. At this point, it can be determined whether the bladder should be actuated, as shown in step 132. The bladder is preferably actuated after the preform is properly situated in the mold cavity, and after the mold cavity is enclosed (e.g., with a mold top of some sort).

Once the preform is properly situated, step 136 comprises causing the mandrel/bladder assembly to conform the preform or causing the preform to conform to at least one interior wall of the mold cavity. The mandrel/bladder assembly and the actuated bladder are caused to continue to form the composite part within the mold cavity until the desired shape is achieved. This may be done with heat being selectively applied, as needed. Prior to deactivating the actuator and removing the mandrel/bladder assembly, a determination may be made as to whether the preform is properly formed, as shown in step 140. If it is determined that the preform is not properly formed, the mandrel/bladder assembly and the actuated bladder (and heat, if needed) may be further applied until the preform takes the desired shape. Once properly formed, the preform may be cooled, as shown in step 144, to produce the desired composite article, which at this stage in the process may be only at least partially finished. Once the preform is cooled, the mold top may be removed, and the mandrel bladder assembly disengaged and removed from the mold cavity and the formed composite article, as shown in step 148. In addition, the release film may be removed from the composite article, as shown in step 152. If it is determined in step 156 that the formed composite article needs further finishing, one or more finishing steps may be utilized to complete the manufacture of the composite article as desired. Step 160 comprises initiating one or more such finishing steps. Each of the above-described bladder molding process and composite article manufacturing steps is discussed in greater detail below.

With respect to the thermoplastic preform, these are advantageous in that they allow for quick processing cycles, since there is no “cure” of the matrix material. To form the composite article, the preform is simply melted, shaped or formed into a desired configuration, and then cooled to cause it to maintain its new shape. The present invention bladder molding system, with its associated mandrel/bladder assembly, as well as the processing method associated therewith, permits thermoplastic composite materials or fibers to be used to form u-shaped, channel and other similarly shaped composite articles where prior related or traditional bladder molding systems would pose many significant process challenges when used with thermoplastic preforms. Some of these problems are discussed above and elsewhere herein.

Many different types of thermoplastic composite materials are contemplated for use with the present invention bladder molding systems and methods. Some of the more common types include, but are not limited to, s-glass, e-glass, Kevlar, and graphite.

Obtaining a mold having a mold cavity configured to facilitate formation of a desired composite article may comprise obtaining or constructing various mold types of various configurations. Although the fabrication of u-shaped or channel shaped composite articles is the focus herein, such as for the purpose of fabricating ladder rails, other mold and mold cavity geometries are contemplated for producing composite articles of different configurations. The molds used are intended to be operable with the present invention bladder molding systems discussed herein.

In one exemplary embodiment, the molds may be formed from one or more aluminum sheets bent into a particular geometry. For example, in the case of a mold used to fabricate composite ladder rails, the mold may be formed from aluminum sheets, having a thickness between 0.05 and 0.1 inches thick, and preferably around 0.05-0.07 inches thick, wherein the mold is formed through shearing and breaking to achieve the outside part dimension, plus any required mold flanges. Using this technique, there may be a seam formed in the center where the two sheets would meet in the event a lengthy mold is needed. The aluminum may function as a liner that could sit inside a CNC machined MDF carrier, to provide the bulk and stiffness required to mold the composite articles. The advantages of this type of mold would be low cost while providing a high degree of flexibility. In addition, finished composite article quality is expected to be high, with minimal costs. If needed, a new mold can be built in a short amount of time, such as within a few days.

In another exemplary embodiment, the molds may be formed in accordance with the mold just described, with the addition of a cooling system designed to facilitate the cooling of the thermoplastic once molded or formed in the desired shape by the mandrel/bladder assembly. The cooling system may comprise many different designs as recognized by those skilled in the art. In one aspect, the cooling system may comprise a series of aluminum square tubing profiles located behind the aluminum insert used to form the mold, through which flows a circulating coolant to draw heat from the mold that builds up through repetitious processing of hot thermoplastic materials. The coolant system and the coolant may be controlled using known controlling means. Other cooling systems that may be used within the bladder molding system will be apparent to those skilled in the art. Essentially, any cooling system may be used that effectively reduces the temperature of the thermoplastic at desired, select times.

As stated, it is contemplated that the molds, and mold cavities, may be configured differently in order to fabricate geometrically different composite articles. As such, it is contemplated that the present invention bladder molding systems and methods be able to accommodate or operate with different mold geometries. Indeed, it may be desirable to modify composite part or article geometry for many reasons, such as to strengthen a particular part in a particular area, etc. Changes in composite part geometry may be as simple as adding or removing fiber reinforcement, adding a core material for better stiffness/weight properties, or changing the part geometry altogether. With such changes may come the need to modify or change the mold geometry, or to interchange one mold with another having a different geometry. As a result, different molds having different geometries are contemplated for use. In any event, it is intended that the present invention bladder molding system, and particularly the mandrel/bladder assembly discussed herein, be operable with different molds and mold cavities, particularly within a certain range of geometries.

Moreover, it is contemplated that the mold top used to enclose the mold cavity be operable with the mandrel/bladder assembly. The mold top may be configured to cover and enclose the mold cavity, and also to provide an upper barrier for at least a portion of the bladder as it is actuated. The interaction of the mold top, the mandrel and the bladder is discussed in greater detail below.

In this particular method, the present invention bladder molding system operates to index and suspend the thermoplastic preform above the mold cavity prior to coming in contact with the mold, and prior to application of the mandrel/bladder assembly component of the bladder molding system to cause the preform to conform to the mold cavity. This may done for several purposes. In essence, the release film may function as a carrier for the preform, which may effectuate improved heating of the preform and facilitate insertion into the mold cavity in addition to performing traditional functions as known in the art.

In one aspect, the preform is suspended using a release film configured to function both as a support for the preform, and also as a release layer during the fabrication of the composite article, in which the release film facilitates the removal of the composite article from the mold cavity after formation. The release layer may be supported in a suspended manner above the mold cavity either in a relaxed or pre-tensioned condition.

As another beneficial function, the release film may enable the use of smaller or less pronounced draft angles within the mold cavity, meaning the angle of the respective sides of the mold cavity with respect to the horizontal bottom surface. In many prior related processes, the draft angle was required to be greater than desired in order to enable the finished composite article to release and be removed from the mold cavity. With the release film of the present invention, it is contemplated that the draft angles of the mold cavity may be reduced, as compared to the draft angles of a mold cavity in a similar prior related process used to form a similar composite article. A release film, accompanied with a reduction in draft angles, will facilitate removal or de-molding of the finished composite article to a greater degree. In the example of a composite article having a channel shape, the release film may permit the mold cavity to comprise near 90° draft angles, thus producing a composite article, or ladder rail, having truer perpendicular side walls. By near 90° draft angles it is meant draft angles ranging between 83° and 89.9°.

In this particular method, the preform may be heated prior to coming in contact with the mold. Heating the thermoplastic preform to a temperature in cooperation with a molding temperature, and evenly and thoroughly heating the preform, may be performed using any known heating system. In one aspect, the heaters used to heat the thermoplastic preform may be infrared heaters. The heaters may be supported in any manner, and any number of heaters may be used. The heaters should be configured and arranged in a manner so as to sufficiently heat the thermoplastic preform to a pre-determined temperature throughout, which pre-determined temperature is at least a molding temperature of the thermoplastic preform permitting it to deform and conform to the mold cavity.

Positioning a mandrel/bladder assembly proximate the suspended preform and the mold cavity may be performed by obtaining and positioning a bladder molding system having a mandrel/bladder assembly. Exemplary bladder molding systems are discussed below. In any event, the mandrel/bladder assembly is intended to be properly positioned so that it is capable of forcing the preform (such as is suspended about the release film) into the mold cavity upon the preform being heated to the desired molding temperature. With the preform properly indexed, the mandrel/bladder assembly may be caused to contact the preform to initiate insertion of the release film, if present, and the preform into the mold cavity and to initiate forming of the preform into the desired shape to achieve the desired composite article. The mold may be a component of the bladder molding system, or it may be a separate and independent component/system.

One of the unique functions of the mandrel is to index the preform not only prior to and as it is being inserted into the mold cavity, but also within the mold cavity. The presence of the mandrel helps to maintain a proper position of the preform with respect to the mold and mold cavity.

The mandrel is sized and configured to support and be operable with an actuatable bladder. The mandrel is also sized and configured to be operable with or interface with the mold top. In one aspect, the bladder is configured to be supported about the bottom surface and at least part of each side of the mandrel, leaving the top of the mandrel exposed. In this manner, the mold top may be caused to interface with or rest on the top surface of the mandrel as it encloses the mold cavity. With the top surface of the mandrel interfaced with the mold top, the bladder may be sized and configured so that it is not required to fill the entire volume of the mold cavity. In other words, the mandrel may be sized and configured to fill at least a portion of the mold cavity, but only between the mandrel and the composite article, thus effectively reducing the volume of space required to be filled and pressurized by the bladder. Additionally, the mandrel, as interfacing with the mold top, significantly reduces the amount of surface area of the mold top that is exposed within the mold cavity, and that is contemplated to come in contact with the bladder, upon actuation thereof, once the mold top is positioned about the mold cavity.

The volume of space within the mold cavity may be defined as the space or gap between the bottom and side surfaces of the mandrel and the composite preform or article once indexed and positioned within the mold cavity. This distance or gap, and hence the resulting volume, may vary as needed. Suffice it to say, the greater the distance is between the mandrel surfaces and the composite preform the greater the volume of space will be that will be required to be filled by the bladder, and the greater the amount of pressure that will be needed to properly form the composite article. However, the distance should not be so small so as to interfere with the proper formation of the composite preform. The distance should accommodate the bladder and a degree of expansion thereof, upon actuation. In addition, the distance should be sufficient to enable and maintain proper indexing of the preform by the mandrel/bladder assembly as the bladder expands.

The mandrel is intended to provide one or more counteracting forces on the bladder opposite those exerted on the bladder by the preform and any exposed surfaces of the walls of the mold cavity and the mold top. In other words, the bladder is intended to press against the composite preform, the exposed surfaces of the walls of the mold cavity and the mold top, as well as the mandrel, with the mandrel being positioned to counteract the forces on the bladder by the composite preform and the exposed surfaces of the walls of the mold cavity and the mold top. In this respect, the pressure needed to form the composite article may be reduced since the overall surface area to be pressurized by the bladder is significantly reduced. The force or pressure needed to retain the mold top in position about the mold cavity may also be reduced. Other unique features of the mandrel are discussed herein.

Once the preform is properly inserted within the mold, the mandrel/bladder assembly may be secured into place to enable the mandrel/bladder assembly to be actuated to cause the preform to conform to at least one interior wall of the mold cavity. More specifically, in order for the mandrel/bladder assembly to cause the preform to conform to one or more walls of the mold cavity, the mandrel/bladder assembly may be first secured in place prior to the bladder being actuated and pressurized to a pre-determined pressure. By securing the mandrel/bladder assembly, unwanted movement is eliminated or at least significantly reduced, thus resulting in more accurate conforming of the preform to the mold cavity, and ultimately more accurate formation of the composite article.

As stated, pressurizing the bladder functions to cause the preform to conform to the walls of the mold cavity for the purpose of forming the composite article. The bladder is designed to be operable with and supported about the mandrel. Unlike the bladders in prior related bladder molding systems, the bladder of the present invention may be sized and configured so as to only fill the volume of space created between the mandrel and the preform, and any exposed surfaces of the mold cavity and/or mold top. As the bladder is caused to be pressurized, it presses against the surfaces of each of these elements, and causes the preform to conform to the walls of the mold cavity and to take the desired configuration or shape.

Cooling the preform to produce a composite article, being at least partially finished, may comprise passive or active cooling. Passive cooling may involve letting the formed composite article cool down under ambient conditions (i.e., room temperature) prior to being removed from the mold. Active cooling may comprise initiating a cooling system operable with the mold and/or the bladder molding system to subject the mold and the formed composite article contained therein to a coolant prior to the composite article being removed from the mold. While passive cooling may constitute reduced equipment costs, active cooling may significantly decrease the time required to cool the composite article, thus also decreasing the cycle time between parts to be manufactured, and thus allowing a greater number of composite articles to be formed within a given time period.

As discussed above, the presence of the mandrel functions to reduce the volume of space or void within the mold cavity existing between the mandrel and the composite preform and resulting article. This effectively reduces the volume of coolant needed to cool the formed composite article since the coolant is only required to fill this void between the mandrel surfaces and the composite article. Reducing the volume of space and the amount of coolant needed also functions to reduce the cooling time needed to cool the composite article, thus further contributing to a reduction in cycle times between composite articles to be manufactured or fabricated.

Once cooled, the composite article, although perhaps only partially finished, may be removed from the mold. In order to remove the formed composite article, the mandrel/bladder assembly is first deactivated and then released and removed from the mold cavity, thus allowing the composite article to be removed. With the mandrel/bladder assembly out of the way, the composite article may be removed from the mold in accordance with practices commonly known in the art.

Coming out of the mold, the composite article may likely have the release film still attached thereto. As such, a step in the process might include removing the release film from the composite article. This may also be accomplished in accordance with practices commonly known in the art.

As indicated, one or more finishing steps may be required to complete the process and to obtain a completely finished, ready-to-use composite article. Additional finishing steps may include, but are not limited to, cutting off of one or more unwanted portions of the composite article, and/or smoothing an edge or surface of the composite article. For example, in the case of a manufactured composite ladder rail, there may be a thin, sharp flange running the length of the composite rail. The preform may be designed with this in mind, and sufficient material allotted for trimming of the rails. Trimming may be accomplished with a band saw and fence system, or a power feed system. Trimming of the length of the rails may also be required, which trimming may be accomplished in a similar manner.

After trimming, the exposed ends or edges of the composite article may be too rough for comfortable handling by hand or for end use. As such, one or more further finishing operations may be initiated to mask or eliminate the roughness of the composite article. For example, in one aspect, a rubber, snap-on trim member, such as a TrimLok trim member, may be fitted onto an edge or end of the composite article. The trim member may be installed manually or in a roll-on application. In another aspect, the composite article, or a representative portion thereof, may be re-melted with the sharp or rough edges being subjected to a rounding or beveling process that involves concentrating a propane flame or one or more electric infrared heaters on the sharp edges and continuously moving the composite article through these using a variable-speed power feeder that feeds the hot rough edges of the composite article underneath a spring-loaded, machined PTFE former, which results in a consistent, smooth edge. In still another aspect, the rough edges may be subjected to reheating and forming using a wet grinding treatment.

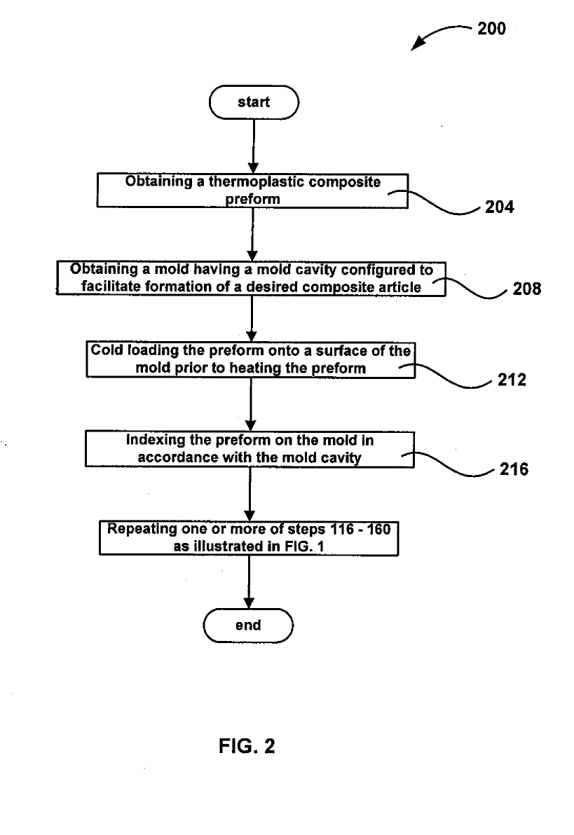

With reference to FIG. 2, illustrated is a flow diagram depicting a bladder molding process, and a method for manufacturing a composite article formed from a thermoplastic preform in accordance with another exemplary embodiment of the present invention. This particular method is similar in many respects to the exemplary method and bladder molding process described above and shown in FIG. 1, with various differences that will be described below. As such, the discussion above with respect to FIG. 1 is intended to be incorporated herein, where applicable.

Specifically, as shown in FIG. 2, the method 200 comprises several steps. As illustrated in step 204, the method 200 comprises obtaining a thermoplastic composite preform. Step 208 comprises obtaining a mold having a mold cavity configured to facilitate formation of a desired composite article. The mold is intended to comprise a mold cavity, or more particularly an opening of the mold cavity, that is at least slightly smaller in dimension along at least one axis than the dimensions of the composite preform in order to facilitate step 212 of cold loading the preform onto a surface of the mold prior to heating the preform. Cold loading represents part of an alternative manufacturing process or method, replacing the step of suspending the preform on a release or other film as described above.

Cold loading the preform may further comprise indexing the preform with respect to and in accordance with the mold cavity of the mold, as shown in step 216, in anticipation of properly inserting and situating the preform within the mold cavity. Once the preform has been properly cold loaded, one or more of steps 116-160 as illustrated in FIG. 1 and discussed above may be repeated to form a finished composite article.

With respect to the step of cold loading the composite preform, the preform may be moved into position about the mold and mold cavity prior to the preform being heated. Once in place, the preform may be heated in a similar manner or as is done in prior related thermoforming techniques. However, unlike prior related thermoforming methods, there is no significant “handling” (moving, transporting, positioning, indexing, etc. the composite preform, such as into the bladder molding system and/or about the mold and mold cavity) of a “soft” (meaning a heated or hot preform) composite preform. Rather, the preform, at an ambient, non-elevated temperature, is loaded and positioned/indexed into the bladder molding system over the mold cavity in a substantially final pre-load position. Thus, after heating, the preform will not require any significant movement, if any at all. Small manipulations of the preform prior to forcing it into the mold cavity may be conducted if necessary, but commonly known “handling” of the preform may be substantially, if not completely, eliminated.

Cold loading of the composite preform provides several significant advantages, one of which includes ease of handling of the composite preform. Indeed, at ambient temperature conditions, the composite preform may be manipulated, moved, transported, positioned, indexed, etc. easily since it is respectively more rigid as compared to a hot or soft (heated) preform, which can have a tendency to droop or sag, and which can be much more difficult to handle. Another advantage is that the composite preform may be situated in a final pre-load position prior to heating, whereupon after heating of the composite preform is complete, the heaters may be deactivated and/or retracted and the mandrel/bladder assembly brought down into contact with the composite preform without having to further handle the then heated preform. Prior related thermoforming processes often involve a frame to support the composite preform during and after heating. Once heated, the composite preform must be removed from the frame and positioned about the mold cavity. This process is extremely awkward and time consuming. By cold loading the composite preform in accordance with the present invention, many such deficiencies in prior related thermoforming methods or techniques are eliminated.

Once the composite preform is heated to achieve a desired molding temperature, after being cold loaded into the bladder molding system and indexed or positioned about the mold cavity, the bladder/mandrel assembly is brought into position about the composite preform and actuated to press the composite preform into the cavity of the mold. The heated composite preform, as a result of gravity, may partially descend or droop into the mold cavity upon being heated and prior to interaction with the bladder/mandrel assembly. If the degree of descent or drooping of the composite preform is too great or is uneven (this may depend upon the size and/or geometry of the composite preform) then the above-described method of suspending the preform using the release film, or simply disposing a release film between the preform and the mold, may be utilized. It is noted that in some cases with the preform cold loaded onto the mold and about the mold cavity, heating of the preform will function to partially mold the preform as it rests on the mold. Additional molding will obviously occur once the preform reaches its target molding temperature and once the mandrel/bladder assembly is actuated. However, partial molding may be advantageous in both facilitating the insertion of the preform into the mold cavity, as well as in conforming the preform to the walls of the mold cavity.

Going back to the example of forming thermoplastic composite ladder rails, the preforms used to form these rails may be flat and may have a width that exceeds the width of the mold cavity. As such, one will be able to lay a cold preform on the “lip” of each side of the mold about the mold cavity. Once in place, the preform may be heated, and once heated, the heaters retracted and the bladder/mandrel assembly moved into position to push the preform into the mold cavity, after which the bladder/mandrel assembly is secured in place and the bladder actuated, as discussed above. The formed composite preform is then cooled and removed from the mold to provide the desired composite article.

It should be noted that a release film, similar to the one discussed above, may also be utilized during a cold loading process, which release film may be caused to be located between the cold preform and the mold surface prior to laying the preform on the mold, or prior to cold loading the preform. The release layer may perform multiple functions, such as to facilitate the release of the preform from the mold once formed and cooled, to prevent unwanted sagging or drooping of the composite preform into the mold cavity as it is heated and as it approaches its molding temperature, as well as to facilitate removal or de-molding of the composite article.

As with the embodiment of FIG. 1, in an alternative manufacturing method, the preform may be preheated prior to being loaded directly onto the upper surface of the mold and indexed about the mold cavity (such as within an external, off-line heating device). Once heated to a proper molding temperature, the preform may be loaded onto the mold surface and properly indexed. As such, both cold loading and hot loading of the preform onto the mold prior to being inserted into the mold cavity are contemplated by the present invention.

### Bladder Molding System

The present invention further features a bladder molding system for the manufacture of channel and other similarly shaped composite articles. In many respects, the present invention bladder molding system facilitates the formation of such composite articles in accordance with the above-described methods.

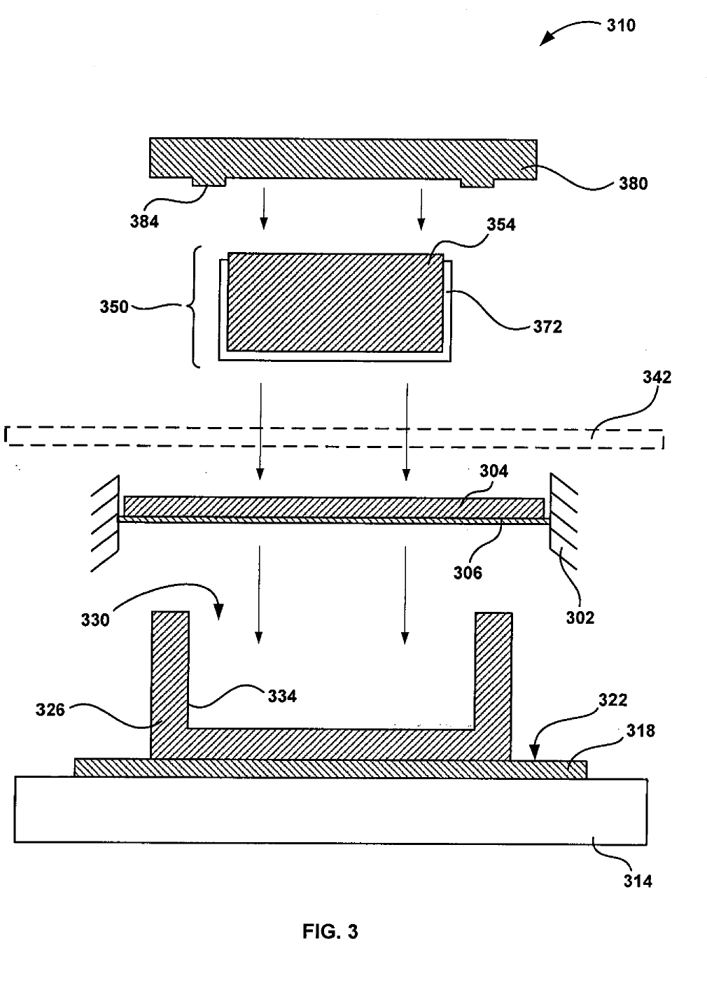

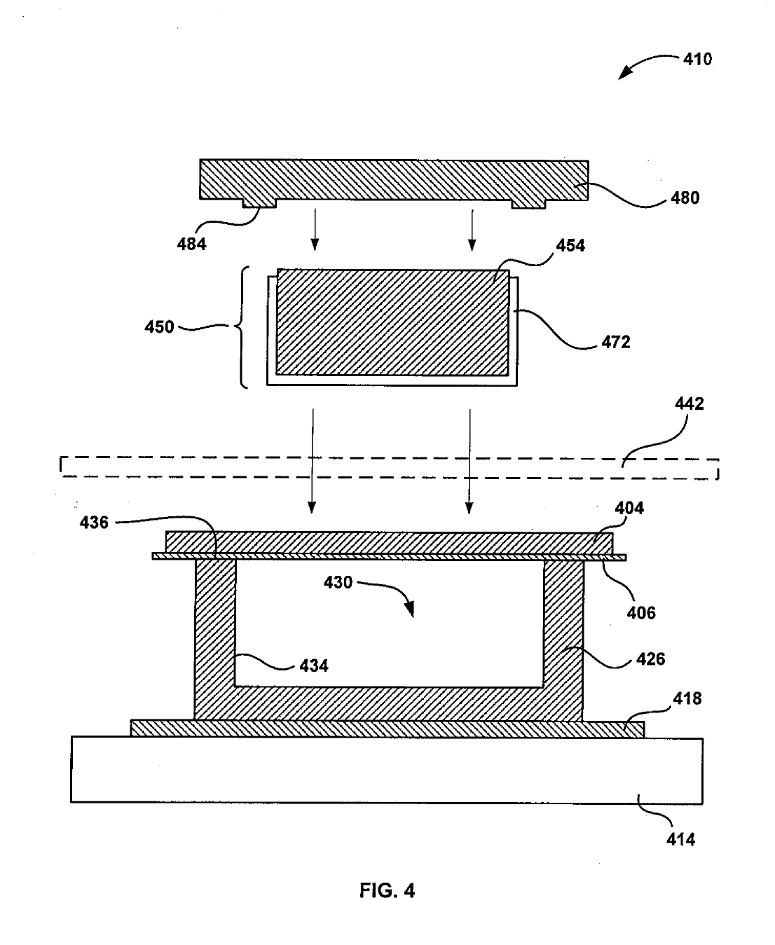

FIGS. 3-4 illustrate general block diagrams of two exemplary bladder molding systems in accordance with the present invention.

FIG. 3 illustrates a bladder molding system 310 that may be used to form a composite article in accordance with the method described above and shown in FIG. 1 (suspending a preform on a tensioned release film).

As shown, the bladder molding system 310 comprises a fundamental framework 314, to which additional components may be added and removed to enhance the system, and to improve the efficiency of the manufacturing process, such as to reduce labor or increase cycle times as needed or desired. In some exemplary embodiments, the fundamental framework 314 or structure may comprise a plurality of steel support beams that may be arranged in any configuration with respect to one another (for example, the support beams may be arranged parallel to one another). Depending upon the type of composite articles to be fabricated, the framework may also comprise different sizes. For example, in the event of fabrication of ladder rails, the steel beams may be between 12 and 20 feet long.

Although not shown, the support beams within the framework 314 may be affixed atop a plurality of support legs, which may also be part of the framework 314, and which may function to bring the working surface 322 of the platen 318 to a comfortable height. The support legs may be adjustable in height so as to vary the height of the platen 318, and ultimately the mold 326.

A relatively flat platen 318 may be situated above and supported by the framework, namely the support beams, which platen 318 functions as a support surface on which a mold having a mold cavity may rest. Specifically, the platen 318 may function to provide a working surface 322 for supporting the mold. As will be recognized, the platen 318 may be any size, type and configuration as needed.

One or more heaters 342 may be provided to heat the preform to an elevated temperature, such as to a part forming temperature. Different types, sizes, and numbers of heaters may be used depending upon a variety of factors, such as the desired cycle time, the composite article being manufactured, etc.

In one exemplary embodiment, the heater 342 may comprise a series of electric infrared heaters supported on a moveable unit that is itself supported on a track, thus allowing the heaters to be positioned in place directly over the mold during the heating cycle, and then subsequently retracted out the way of the mandrel/bladder assembly during the pressure, loading, and unloading cycles. Details of the structure and system of the movable unit used to position and retract the heaters is not specifically set forth herein. However, those skilled in the art will recognize various existing methods and systems that may be used to manipulate the heaters.

In another exemplary embodiment, heater 342 may comprise an external heating device configured to receive the cold preform 304 therein, and to heat the preform 304 to a predetermined temperature for a predetermined duration of time (to reach the formable temperature). Once heated, the preform may be removed from the heating device and placed within the bladder molding system as described herein. In each of these embodiments, the preform 304 is preheated prior to being inserted into the mold cavity 330.

Heater 442 is shown in phantom lines to indicate that the heater or heaters are operable with the bladder molding system only at select times, and that the heater(s) may be brought into position and moved out of the way as needed, or provided off-line in an external heating device.

The bladder molding system 310 further comprises a mandrel/bladder assembly 350 comprising a mandrel 354 and a pressurizeable (e.g., inflatable) bladder 372 that encases at least part of the mandrel 354, and that provides an airtight seal. As discussed herein, the present invention bladder molding system 310 comprises a mandrel/bladder assembly 350 which facilitates the process of forming the thermoplastic preform 304 within the mold cavity 330. The mandrel/bladder assembly 350, heaters 342, and clamping mechanism are all operable together to provide the advantages of the present invention. The mandrel/bladder assembly 350 facilitates initiation of the forming process, may act as the upper mold when clamped in place, and induces the full needed molding pressure.

The mandrel/bladder assembly 350 may be constructed, in part, of a rigid frame. In one exemplary embodiment, the mandrel/bladder assembly 350 may comprise, in part, an aluminum frame of sufficient strength to handle the molding pressure while being held in place by the clamping mechanism. Below the aluminum frame may be a hollow aluminum rectangular extrusion member (e.g., one off the shelf which functions as the mandrel 354. As discussed herein, the mandrel 354 supports the bladder 372, and functions to initiate the forming of the preform 304 by pressing it into the mold cavity 330 of the mold 326, and causing portions of the preform to fold upwards against the inner walls 334 of the mold cavity 330 to form the channel shaped composite article. In this respect, problematic “bridging” is eliminated, which problem is known in the art. Essentially, bridging occurs in prior related bladder molding systems where the fibers of the preform are pulled too tight for the bladder to force them against the walls of the mold cavity.

The extrusion member or mandrel 354 is encased, at least in part, in a resilient, airtight membrane or bladder 372. The resilient membrane or bladder 372 may comprise a shape to match that of the aluminum extrusion member or mandrel 354.

While a variety of different types of materials are contemplated for use herein for the resilient membrane or bladder, silicone may be a preferred material of choice for many applications due to its ability to withstand higher temperatures of thermoplastic molding, its high elongation, its ability to achieve even pressure distribution, its availability, and its inherent non-stick properties.

In one aspect, as discussed above, the bladder 372 may be supported about only a portion of the mandrel 354, namely the bottom and side surfaces of the mandrel 354, with the top of the mandrel 354 being left exposed as shown in the drawings. In this respect, the top surface of the mandrel may be caused or allowed to come in contact and interface with a mold top 380 used to enclose the cavity 330 of the mold 326. In addition, the bladder 372 may be configured to extend along a majority of the side surfaces of the mandrel 354, leaving a gap or space along the side surfaces that is not encased by the bladder 372. In this manner, the mold top 380 may comprise one or more ribs 384 that extend down into the mold cavity 330 upon the mold top 380 being placed on the mold 326. The ribs 384 may be sized and configured to span or extend between the inner walls 334 of the mold 326 and the mandrel 354, and to extend downward so that they terminate just prior to or adjacent the bladder 372.

The aluminum extrusion or mandrel 354 may also serve as an air distribution manifold for delivering high pressure air into the resilient membrane or bladder 372 quickly and evenly along its length. This may be accomplished in different ways, such as through holes drilled at regular intervals in the mandrel 354.

The bladder molding system 310 may still further comprise a clamping mechanism, such as a lengthwise clamping mechanism, to secure the mandrel/bladder assembly 350 in place during operation. Utilizing a clamping mechanism, the mandrel/bladder assembly 350 may be clamped, such as along its entire length, eliminating the need for a large structure to withstand the loads the mandrel/bladder assembly will exert during operation and while under pressure.

Below the support beams, a pneumatic system, comprising one or more pneumatic cylinders, may be utilized, which system may function to selectively manipulate and move the clamping mechanism during the pressure and part formation cycle.

FIG. 3 further illustrates, and the bladder molding system 310 further comprises, the preform 304 suspended above the mold 326 and mold cavity 330. The preform 304 is shown as being supported by a release film 306 spanning between supports 302. In this manner, the bladder molding system 310 operates to index and suspend the preform 304 above the mold cavity 330 prior to coming in contact with the mold 326, and prior to application of the mandrel/bladder assembly 350 to cause the preform to conform to the mold cavity 330. Suspending the preform 304 may function to facilitate better indexing of the preform 304 with respect to the mold cavity 330, may effectuate improved heating of the preform 304, and facilitate more precise insertion of the preform 304 into the mold cavity 330. The preform may be suspended using a release film configured to function both as a support for the preform, and also as a release layer during the fabrication of the composite article. The release layer may be supported in a suspended manner above the mold cavity either in a relaxed or pre-tensioned condition. Examples of various types of release films contemplated for use herein include, but are not limited to films coated with Polytetrafluoroethylene (PTFE), with non-porous PTFE films being the preferred type.

FIG. 4 illustrates a bladder molding system 410 that is similar to the bladder molding system 310 of FIG. 3, but that may be used to form a composite article in accordance with the method described above and shown in FIG. 2 (cold loading a preform into the bladder molding system and about the mold cavity of a mold). The bladder molding system 410 may comprise some or all of the same or similar components as the bladder molding system 310, such as a framework 414 used to support a platen 418 and that which provides a working surface 422 for a mold 426 having a mold cavity 430, a clamping mechanism, one or more heaters 442, a mandrel/bladder assembly 450 comprising a mandrel 454 and a bladder 472, and a mold top 480 having optional ribs 484. The description of each of these components provided above with respect to FIG. 3 is incorporated herein, where applicable.

Unlike the bladder molding system of FIG. 3, bladder molding system 410 utilizes and facilitates a cold loading process, wherein the preform 404 is cold loaded directly onto an upper surface 436 of the mold 426, and indexed thereon with respect to the mold cavity 430. A release film 406 may be used if needed or desired. Further details regarding cold loading of the preform are discussed above.

The bladder molding system 410 may further comprise indexing means used to facilitate indexing of the preform 404, namely more precise lining up of the preform 404, with respect to the mold cavity 430. Indexing means may comprise a physical indexing bar supported or disposed about the mold 426, such as on the top, back side of the mold surface, which physical indexing bar permits manipulation of the preform 404 to a desired indexing position.

In one aspect of the present invention, select components of the above-described bladder molding systems of FIGS. 3 and 4 may be manually operated. For example, the following operations may be performed manually, namely, loading the preform and indexing it into the bladder molding system about the mold and mold cavity, rolling the heater assembly into place above the preform (which is directly above the mold), actuating the heaters, monitoring the temperature of the composite preform, such as with an infrared thermocouple, deactivating the heaters, retracting the heater assembly into the retracted position, lifting the mandrel/bladder assembly into place, actuating the clamp used to secure the mandrel/bladder assembly in place (e.g., manipulating a valve), pressurizing the mandrel/bladder assembly (e.g., manipulating a valve that controls the pressure source used to pressurizes the mandrel/bladder assembly), monitoring the cool down time and temperature, deactivating or depressurizing the mandrel/bladder assembly, releasing the clamp, lifting the mandrel/bladder assembly out of the mold cavity and out of the bladder molding system, and removing the finished part from the machine.

In one exemplary embodiment, the bladder molding system may comprise a footprint that is approximately 15-20 feet in length (left-to-right) and 3-7 feet in depth (front-to-back). An operator/service space of 3-5 feet on the left, right, and rear of the machine, plus 6-10 feet in front of the machine may be planned for. Power requirements may be one line, 220-240 volt, single-phase, at 50 amps, plus one line, 110-120 volts, 20 amps. Air pressure may be up to 100-150 psi, from a minimum volume compressor tank. Compressor pump volume may be any as needed.

Various components/accessories may be incorporated into the bladder molding system to enhance performance and/or efficiency, such as improve part consistency, labor requirement, and/or cycle times. Some of these components/accessories may include, but are not limited to, digital heating controls to better determine part temperature, powered (pneumatic) movement of the heating assembly, assisted movement of the mandrel/bladder assembly (e.g., using a counterweight, fully unassisted or powered movement of the mandrel/bladder assembly (e.g., pneumatic operation), electro/pneumatic controls for the movement of the heating assembly, mandrel/bladder assembly and clamping mechanism, as well as for the pressurization/depressurization of the mandrel/bladder assembly, PLC controls for cycle automation between loading of the preform blank to removal of the molded part, and the addition of multiple, parallel molds for simultaneously pressing and forming multiple parts. Other components may be incorporated as will be obvious and apparent to those skilled in the art.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A method for facilitating fabrication of a composite article formed from a thermoplastic preform, and within a bladder molding process, said method comprising:
providing a mandrel/bladder assembly operable to conform said preform to one or more walls of a mold cavity of a mold, said mandrel/bladder assembly comprising:
a mandrel sized and configured to fit within said mold cavity, and to define, at least in part, a volume of space between said mandrel and said preform, each as positioned within said mold cavity, and
an actuatable bladder supported about at least a portion of and operable with said mandrel, and configured to fill said volume of space upon being actuated to cause said preform to conform to said walls of said mold cavity; and
facilitating operation of said mandrel/bladder assembly within a bladder molding system to fabricate a composite article.

2. The method of claim 1, wherein said bladder is supported about a bottom and partially about side surfaces of said mandrel, leaving a top surface of said mandrel exposed, said top surface being configured to interface with a bottom surface of a mold top to further reduce said volume of space within said mold cavity.

3. The method of claim 1, further comprising suspending said preform above said mold and said mold cavity prior to heating said preform using a release film.

4. The method of claim 1, further comprising cold loading said preform directly onto a surface of said mold prior to heating said preform and actuating said mandrel/bladder assembly to conform said preform to said mold cavity.

5. The method of claim 1, further comprising:
preheating said preform;
subsequently loading said preheated preform directly onto a surface of said mold; and
indexing said preheated preform about said mold cavity.

6. A method for manufacturing a composite article formed from a thermoplastic preform, and within a bladder molding system, said method comprising:
obtaining a thermoplastic composite preform;
obtaining a mold having a mold cavity configured to facilitate formation of a desired composite article;
supporting said mold to be operable with a bladder molding system;
loading a composite preform onto a surface of said mold and about said mold cavity, said mold being configured to support said preform over said mold cavity;
positioning a mandrel/bladder assembly of said bladder molding system proximate said preform and said mold cavity, said mandrel/bladder assembly comprising a mandrel operable with a bladder;
causing said mandrel/bladder assembly to contact said preform, upon being heated, to initiate formation of said release film and said preform in said mold cavity, and to index said preform within said mold cavity, said mandrel occupying a volume of space within said mold cavity between said mandrel and said preform;
causing said mandrel/bladder assembly to conform said preform to said mold cavity;
cooling said preform to produce a composite article being at least partially finished;
releasing said mandrel/bladder assembly from said mold cavity and said composite article; and
removing said formed composite article from said release film and said mold cavity.

7. The method of claim 6, further comprising preheating said preform using an external heating device to a pre-determined temperature in cooperation with a pre-determined molding temperature prior to said loading said preform.

8. The method of claim 6, further comprising heating said preform using a heating device to a pre-determined temperature in cooperation with a pre-determined molding temperature after said loading of preform.

9. The method of claim 6, wherein said causing said mandrel/bladder assembly to conform said preform to said mold cavity comprises actuating said bladder of said mandrel/bladder assembly.

10. The method of claim 6, wherein said cooling comprises passive cooling in which said preform is allowed to cool under ambient conditions.

11. The method of claim 6, wherein said cooling comprises active cooling in which said preform is subjected to a coolant from a cooling system.

12. The method of claim 6, further comprising enclosing said mold cavity after said preform is inserted and positioned therein.

13. The method of claim 6, wherein said bladder is supported about bottom and side surfaces of said mandrel, leaving a top surface of said mandrel exposed, said top surface being configured to interface with a bottom surface of a mold top to further reduce said volume of space within said mold cavity.

14. The method of claim 13, wherein said mold top further comprises one or more ribs that extend down into said mold cavity and span between said mold and said mandrel, terminating prior to said bladder.

15. A method for manufacturing a composite article formed from a thermoplastic preform, and within a bladder molding process, said method comprising:
obtaining a thermoplastic composite preform;
obtaining a mold having a mold cavity configured to facilitate formation of a desired composite article;
supporting said mold to be operable with a bladder molding system;
indexing said preform on a release film suspended above said mold cavity, said release film being configured to support said preform in a suspended manner;
positioning a mandrel/bladder assembly of said bladder molding system proximate said suspended preform and said mold cavity, said mandrel/bladder assembly comprising a mandrel operable with a bladder;
causing said mandrel/bladder assembly to contact said preform, upon being heated, to initiate formation of said release film and said preform in said mold cavity, and to index said preform within said mold cavity, said mandrel reducing a volume of space within said mold cavity between said mandrel and said preform;
causing said mandrel/bladder assembly to conform said preform to said mold cavity;
cooling said preform to produce a composite article being at least partially finished;
releasing said mandrel/bladder assembly from said mold cavity and said composite article; and
removing said formed composite article from said release film and said mold cavity.

16. The method of claim 15, further comprising preheating said preform using an external heating device to a pre-determined temperature in cooperation with a pre-determined molding temperature prior to placement and indexing said preform on said release film.

17. The method of claim 15, further comprising heating said preform using a heating device to a pre-determined temperature in cooperation with a pre-determined molding temperature after placement and indexing of preform on said release film.

18. A bladder molding system for fabricating a composite article from a thermoplastic preform, said system comprising:
a framework configured to operably support one or more components thereon;
a flat platen operable with the framework and configured to provide a working surface about which a mold having a mold cavity may be supported;
means for supporting said preform about said mold cavity;
a mold top configured to enclose said mold cavity;
a mandrel/bladder assembly movably supported about said framework, and configured to facilitate insertion, forming and indexing of said preform within said mold cavity, said mandrel/bladder assembly comprising:
a mandrel having bottom, top and side surfaces, said mandrel being sized and configured to fit within said mold cavity, and to provide a volume of space between at least said mandrel and said preform, each as positioned within said mold cavity, and
an actuatable bladder supported about and operable with said mandrel, and configured to fill said volume of space to cause said preform to conform to said mold cavity; and
a clamping mechanism configured to secure said mandrel/bladder assembly in a desired position during a pressure cycle.

19. The system of claim 18, further comprising a series of heaters supported on a moveable unit that is supported on a track, which allows said heaters to be positioned in place directly over said mold during a heating cycle, and subsequently retracted out the way of said mandrel/bladder assembly during pressure, loading, and unloading cycles.

20. The system of claim 18, further comprising an external heating device operable with said bladder molding system to preheat said preform prior to being placed within said bladder molding system, and prior to being subjected to said mandrel/bladder assembly.

21. The system of claim 18, further comprising means for suspending said preform above said mold cavity in an indexed manner prior to said preform being heated.

22. The system of claim 21, wherein said means for suspending comprises a release film.

23. The system of claim 18, wherein said means for supporting said preform about said mold cavity comprises a surface of said mold, said surface of said mold being configured to receive said preform, as cold loaded directly onto said mold, and to facilitate the positioning and heating of said preform about said mold cavity prior to insertion into said mold cavity.

24. The system of claim 18, wherein said bladder is supported about a portion of said mandrel, leaving at least a portion of said top surface exposed, said top surface being configured to interface with said mold top to reduce an overall surface area within said mold cavity intended to be pressurized by said bladder.

25. The system of claim 18, further comprising indexing means operable with said mold to more precisely index said preform about said mold cavity.
